(19) United States
(12) Patent Application Publication
(10) Pub. No.: US 2022/0304223 A1
(43) Pub. Date: Sep. 29, 2022

(54) Apparatus and Method for Extending the Output Shaft of a String Trimmer

(71) Applicant: Coby Tabor, Breaux Bridge, LA (US)

(72) Inventor: Coby Tabor, Breaux Bridge, LA (US)

(21) Appl. No.: 17/212,306

(22) Filed: Mar. 25, 2021

(51) Int. Cl. A01D 34/416

(52) U.S. Cl. CPC A01D 34/4165

(57) ABSTRACT

An assembly and method for extending the length of the output shaft of a string trimmer having a threaded output shaft spindle attached to a threaded spindle receiver of a mowing head is disclosed. The assembly and method includes providing a plurality of threadedly attachable shaft extensions preferably of different lengths, detaching the output shaft spindle from the threaded spindle receiver of the mowing head. Selecting a desired shaft extension from the plurality of shaft extensions and threadedly connecting the selected shaft extension to the threaded output shaft spindle and threaded spindle receiver of the mowing head. One or more shaft extensions may be connected together to create a shaft extender positioned between the output shaft spindle and the mowing head of the string trimmer.

### FIELD OF THE INVENTION

This invention relates to string trimmer for lawn maintenance, and more particularly, to an apparatus and method for extending the length of the output shaft of a string trimmer by providing a shaft extender selected from a plurality of interchangeable shaft extensions for selective attachment to the output shaft of the string trimmer.

### BACKGROUND OF THE INVENTION

String trimmers are used in lawn care to cut grass, weeds and other vegetation around trees, fences, sidewalks and flowerbeds. These types of trimmers employ a motor, a longitudinally extending rotatable drive shaft rotated by the motor, a rotatable threaded output shaft spindle at the end of the drive shaft, and a drive shaft housing enclosing the drive shaft. The threaded output shaft spindle is threadedly engaged with and attached to the threaded spindle receiver of a mowing head having one or more flexible lines or pivoting blades. When the output shaft spindle and mowing head are so attached, the rotatable output shaft spindle may be rotated by the drive shaft to rapidly spin the mowing head and correspondingly the flexible lines or pivoting blades for cutting such vegetation.

Typically the length of the drive shaft housing and drive shaft are sized to be used by a person of average height. The National Statistics Report, Number 122 (Dec. 20, 2018) from the U.S. Dept. of Health and Human Services, Centers for Disease Control and Prevention shows that the average height of American men age 20 years old and up is 69.1 inches or about 5 feet 9 inches tall and the average height of all American women was 63.7 inches or about 5 feet 4 inches.

When a string trimmer having a drive shaft housing and drive shaft sized for a person of average height is use by a person that is taller than one of average height, a number of problems are created. Among the problems created include incidences of back and neck strain and increased fatigue experienced by such a user because of the increased need to bend over or stoop when the string trimmer is being used. The increase in bending and stooping may also make a taller user less effective when using the string trimmer resulting in uneven or less uniform cutting of the vegetation. These problems are more pronounced when a user is substantially taller than the average person, such as a user having a height in excess of 6 feet.

Consequently, a need exists for a shaft extender to customize the drive shaft length of string trimmers designed for a user of average height in order to facilitate the use of such trimmers by users that are taller that the height of an average person and reduce the incident of injury and discomfort in such users. There is also a need for a shaft extender to customize the drive shaft length of string trimmers designed for a user of average height in order to allow users that are taller that the height of an average person to use such string trimmers to allow grass, weeds and other vegetation to be cut more effectively and uniformly as desired.

### SUMMARY OF THE INVENTION

Applicants' invention provides a shaft extender apparatus, assembly and method to adjust the length of an output shaft spindle threadedly connected to the threaded spindle receiver of the mowing head of a string trimmer designed for use by a person of average person height. The shaft extender apparatus, assembly and method include providing a shaft extender created from a plurality of interchangeable and threadedly attachable shaft extensions having a variety of lengths. The shaft extender is created by selecting one or more shaft extensions of a desired length from the plurality of shaft extensions and attaching the selected shaft extension or extensions to the output shaft spindle and the spindle receiver of the mowing of a string trimmer to adjust length of the string trimmer. One or more of the selected shaft extensions so attached may also be detached from the output shaft spindle of the string trimmer to again adjust the length of the string trimmer.

A plurality of shaft extensions of different lengths allow a user to selectively choose one or more interchangeable shaft extensions that may then be used singly or connected together to create a shaft extender of a desired length. The shaft extender so created from the selected shaft extension, or extensions, is attached between the output shaft spindle and mowing head to extend the length of the output shaft spindle and increase the length of the string trimmer. The extended length of the string trimmer will make its use be more effective and more comfortable for a taller user.

Each of the interchangeable shaft extensions will preferably have a cylindrical body having a central axis, a preselected length, an upper end, and a lower end. The upper end of the body of each shaft extension has a threaded spindle bore positioned around the central axis of the cylindrical body. The threaded spindle bore is threaded to correspondingly engage with and removably attach to the threaded output shaft spindle of the string trimmer being adapted. The lower end of the cylindrical body of each shaft extension has a threaded shaft aligned with the central axis of the cylinder body that may be threadedly engaged with and removably attached to the threaded spindle receiver of the mowing head or to the threaded spindle bore of another shaft extension.

Only one interchangeable shaft extension may be selected as a shaft extender from the plurality of interchangeable shaft extensions which may then be positioned between the output shaft spindle and the mowing head. Alternatively, two or more interchangeable shaft extension may be selected from the plurality of interchangeable shaft extension which may be then threadedly engaged together as the shaft extender and positioned between the output shaft spindle and the mowing head. Using a shaft extender of two or more interchangeable shaft extensions will increase the range of possible length adjustments provided by the plurality of interchangeable shaft extensions.

Applicants' invention will allow a user to maintain an inventory of interchangeable shaft extensions for a given string trimmer. Because the interchangeable shaft extensions may be readily threadedly attached to and threadedly detached from each other, a shaft extender of a desired length may be created for attachment between the output shaft spindle and the mowing head of a string trimmer in order to accommodate the height of a variety of different users. This is especially advantages to commercial lawn care providers that may employ users having a variety of physical features, body sizes, and heights.

Multiple string trimmers of the same make and model and sets of the interchangeable shaft extensions may be purchased by such commercial lawn care providers. The length of the string trimmers may then be modified as described above so that the string trimmer may be customized and fitted for the physical features, body size, and height of an individual user. Doing so will reduce the incidence of on the job discomfort and the potential for injury by such a user, all resulting in increased job performance and user wellbeing and providing a reduction in absenteeism due to on the job injury.

These and other objects, advantages, and features of this invention will be apparent to those skilled in the art from a consideration of this specification, the claims and the drawings.

### BRIEF DESCRIPTION OF THE DRAWINGS

FIG. 1 and FIG. 2 are partial exploded views of examples of embodiments of rotatable threaded output shaft spindles configured for threaded attachment to the mowing heads at the lower end of the drive shafts of two different string trimmers as known in the art.

FIG. 3 is a perspective view of a plurality of interchangeable shaft extensions of applicant's invention each having a different length to be used as a shaft extender to customize the length of the output shaft spindle of the string trimmer shown in FIG. 1.

FIG. 4 is a side view of a typical interchangeable shaft extension of the plurality of interchangeable shaft extensions shown in FIG. 3.

FIG. 5 is a top view of the typical interchangeable shaft extension of the plurality of interchangeable shaft extensions shown in FIG. 4.

FIG. 6 is a cross-section view of the typical interchangeable shaft extension of the plurality of interchangeable shaft extensions cut along line 5-5 shown in FIG. 4.

FIG. 7 is an exploded view of the rotatable threaded output shaft spindle at the lower end of the drive shaft for attachment to a mowing head of the example of a string trimmer shown in FIG. 1 customized with the addition of a shaft extender comprised of a single selected interchangeable shaft extension from the plurality of interchangeable shaft extensions shown in FIG. 3.

FIG. 8 is an exploded view of a rotatable threaded output shaft spindle at the lower end of the drive shaft for attachment to a mowing head of the example of a string trimmer shown in FIG. 1 customized with the addition of a shaft extender comprised of two selected interchangeable shaft extension from the plurality of interchangeable shaft extensions shown in FIG. 3.

FIG. 9 is a perspective view of a rotatable threaded output shaft spindle at the lower end of the drive shaft for attachment to a mowing head of the example of a string trimmer shown in FIG. 1 customized with the addition of a shaft extender comprised of a two selected interchangeable shaft extension from the plurality of interchangeable shaft extensions shown in FIG. 3.

FIG. 10 is an exploded view of the rotatable threaded output shaft spindle at the lower end of the drive shaft for attachment to a mowing head of the example of a string trimmer shown in FIG. 2 customized with the addition of a shaft extender comprised of a single selected interchangeable shaft extension from the plurality of interchangeable shaft extensions shown in FIG. 3.

### DESCRIPTION OF THE EMBODIMENTS

In the drawings and this description, features that are well established in the art and do not bear upon points of novelty are omitted in the interest of clarity. Such omitted features may include threaded junctures, weld lines, sealing elements, pins and brazed junctures, nuts, washers, and thrust washers or plates.

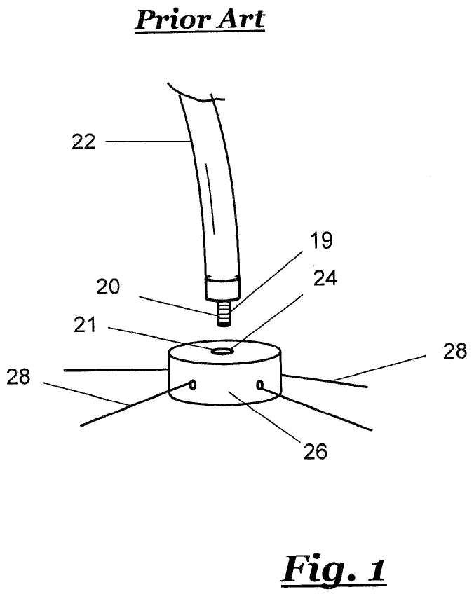

FIG. 1 shows an exploded view of one example of a string trimmer as known in the art. Trimmers of the kind shown in FIG. 1 employ a motor engaged with a longitudinally extending rotatable drive shaft (not shown) enclosed by a drive shaft housing 22. The drive shaft rotates a rotatable threaded output shaft spindle 20 extending from the drive shaft housing 22 that is threadedly attached to a threaded spindle receiver 24 of mowing head 26.

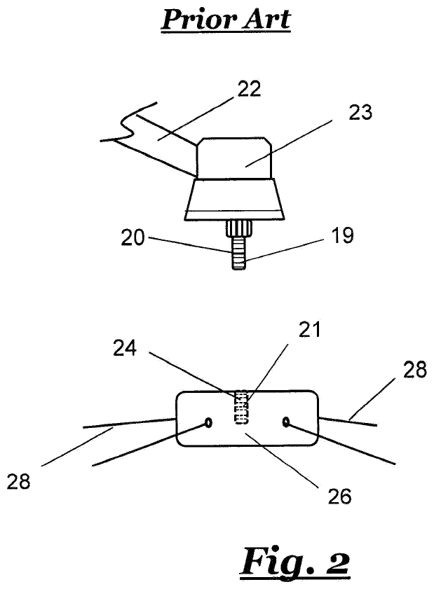

FIG. 2 shows an exploded view of a second example of a string trimmer as known in the art. Trimmers of the kind shown in FIG. 2 employ a motor engaged with a longitudinally extending rotatable drive shaft (not shown) enclosed by a draft shaft housing 22 and gear box 23 at the end of the drive shaft housing 22. The drive shaft rotates a rotatable threaded output shaft spindle 20 extending from the gear box 23 that is threadedly attached to a threaded spindle receiver 24 of mowing head 26.

The threaded output shaft spindles 20 shown in FIG. 1 and FIG. 2 have threads 19 that are configured to be threadedly engaged with and attached to the threads 21 of the threaded spindle receiver 24 of a rotatable mowing head 26. The mowing head 26 is provided with one or more flexible lines or pivoting blades 28. When the threaded output shaft spindle 20 and mowing head 26 are so attached, the rotatable output shaft spindle 20 may be rotated by the motor and drive shaft to rapidly spin threaded output shaft spindle 20 and the attached the mowing head 26 and correspondingly the flexible lines or pivoting blades 28 for cutting such vegetation. Current examples of such string trimmers include the Stihl® FS55 and FS90 string trimmers as manufactured by Andreas Stihl AG & Co., KG, the Poulan® PR28-CD string trimmer as manufactured by Husqvarna AB, and the Troy-Bilt® TB27 BC string trimmer as manufactured by Troy-Bilt, LLC.

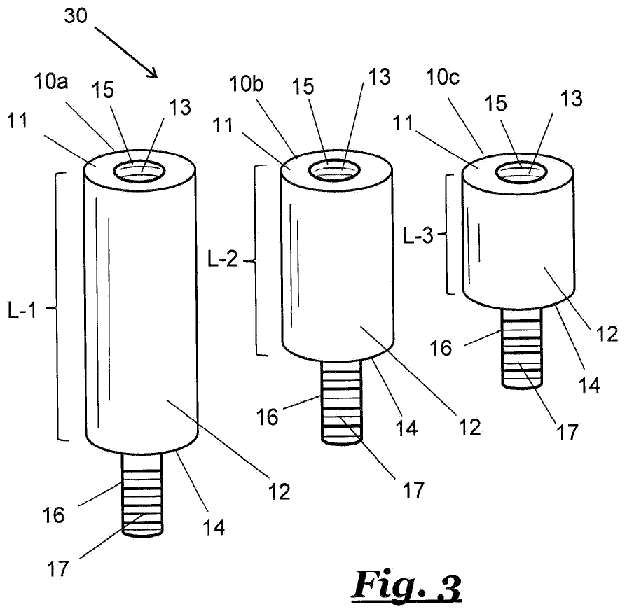

FIG. 3 shows a plurality of cylindrical shaft extensions 30 that may be used for creating a shaft extender 10 described herein. The plurality of cylindrical shaft extensions 30 is comprised of a collection of cylindrical shaft extensions, shown by way of example as shaft extensions 10a, 10b, and 10c. Each shaft extension 10a, 10b, and 10c having an elongated cylindrical body 12 of any desired length, respectively designated lengths as L-1, L-2, and L-3, an upper end 11 with a threaded spindle bore 15 with threads 13, and a lower end 14 with a threaded shaft 16 with threads 17. While the plurality of cylindrical shaft extensions 30 is shown as being comprised of three shaft extensions designated as 10a, 10b, and 10c, the plurality of cylindrical shaft extensions 30 be comprised of any desired number of such shaft extensions.

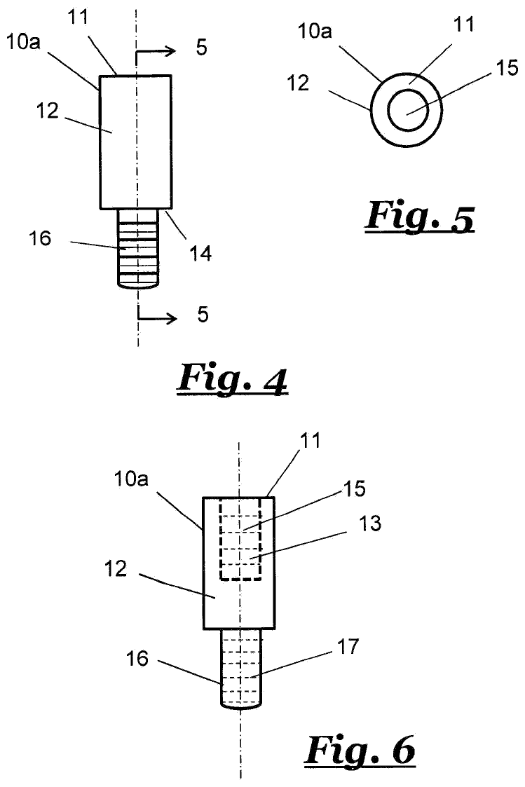

FIGS. 4-6 further show additional views of shaft extension 10a from the plurality of shaft extensions 30 shown in FIG. 3. Threaded spindle bore 15 is centered on the upper end 11 of the cylindrical body 12 and the threaded shaft 16 is centered on the lower end 14 of the cylindrical body 12. The threads 13 of the threaded spindle bore 15 are threaded to correspond and attach with the threads 19 of the output shaft spindle 20 of the string trimmer and the threads 17 of the threaded shaft 16 are threaded to correspond and attach with the threads 21 of the threaded spindle receiver 24 of mowing head 26 of the string trimmer. While the body 12 of the example of the shaft extension 10a is shown and described as cylindrical, the body 12 may be constructed of any suitable shape such as that of a rectangular prism.

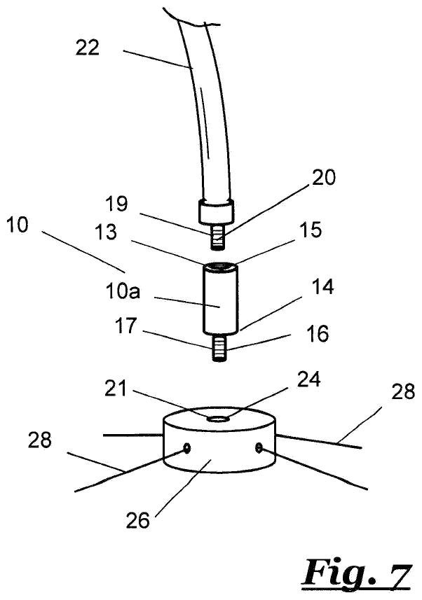

FIG. 7 shows an exploded view an example of the extension of the length of the output shaft spindle 20 of the string trimmer shown in FIG. 1 by attachment of the shaft extender 10 comprised of a single selected shaft extension, shown as shaft extension 10a, from the plurality of shaft extensions 30 depicted in FIG. 3. The threads 13 of the threaded spindle bore 15 of selected shaft extension 10a of the shaft extender 10 are threadedly attached to the threads 19 of threaded output shaft spindle 20 at the end of the shaft housing 22 of the string trimmer. The threads 17 of the threaded shaft 16 of selected shaft extension 10a of the shaft extender 10 are threadedly attached to the threads 21 of the threaded spindle receiver 24 of mowing head 26 to secure the mowing head 26 in place on the string trimmer at the lower end 14 of shaft extension 10a of shaft extender 10.

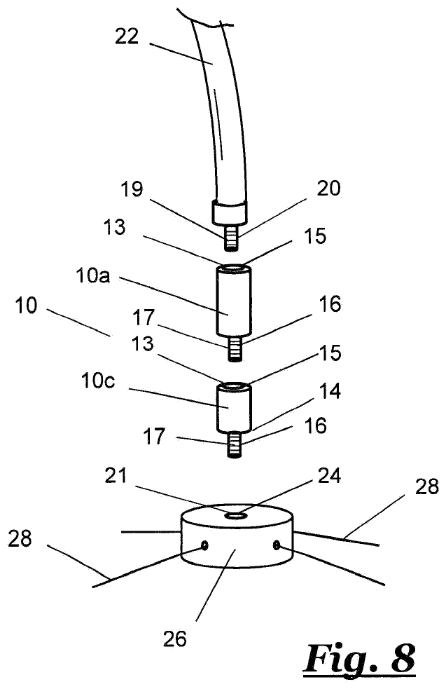

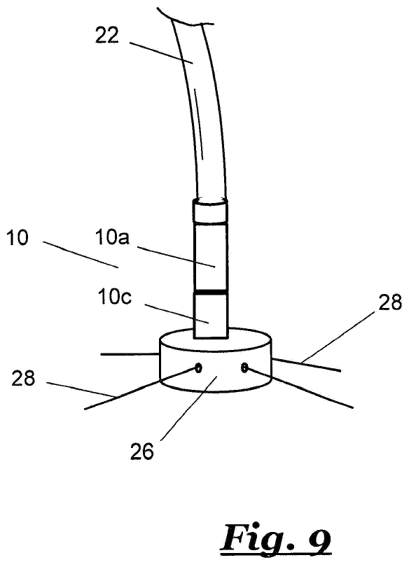

FIG. 8 shows an exploded view of an example of the extension of the length of the output shaft spindle 20 of the string trimmer shown in FIG. 1 by attachment of the shaft extender 10 created by connecting multiple selected shaft extensions, shown for example as shaft extensions 10a and 10c, selected from the plurality of shaft extensions 30 depicted in FIG. 3. The threads 17 of threaded shaft 16 of shaft extension 10a are threadedly attached to the threads 13 of threaded spindle bore 15 of shaft extension 10c to created shaft extender 10. The threads 13 of threaded spindle bore 15 of shaft extension 10a of shaft extender 10 are threadedly attached to the threads 19 of output shaft spindle 20 of the string trimmer and the threads 17 of threaded shaft 16 of shaft extension 10c are threadedly attached to the threads 21 of spindle receiver 24 of mowing head 26 to secure the mowing head 26 in place on the string trimmer at the lower end 14 of shaft extension 10c of the created shaft extension 10. FIG. 9 shows an assembled view of FIG. 8 showing the shaft extender 10 created from shaft extensions 10a and 10c in place between the output shaft spindle 20 and the mowing head 26 of the string trimmer shown in FIG. 1.

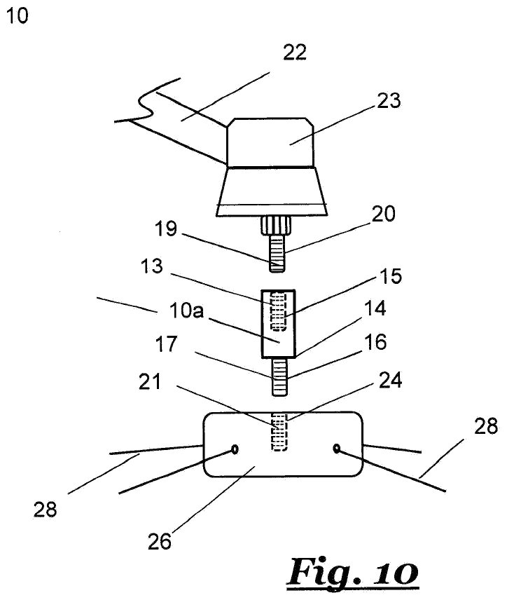

FIG. 10 shows an exploded view an example of the extension of the length of the output shaft spindle 20 of the string trimmer shown in FIG. 2 by attachment of the shaft extender 10 comprised of a single selected shaft extension, shown as shaft extension 10a, from the plurality of shaft extensions 30 depicted in FIG. 3. The threads 19 of output shaft spindle 20 extending from the gear box 23 at the end of the shaft housing 22 of the string trimmer are threadedly attached to the threads 13 of threaded spindle bore 15 of the selected shaft extension 10a of shaft extender 10. The threads 17 of threaded shaft 16 of shaft extension 10a of shaft extender 10 are threadedly attached to the threads 21 of threaded spindle receiver 24 of mowing head 26 to secure the mowing head 26 in place on the string trimmer at the lower end 14 of shaft extension 10a of shaft extender 10.

The method of the present invention, shown in FIGS. 7 and 10, includes (1) providing a string trimmer having a rotatable threaded output shaft spindle 20 at the end of the drive shaft housing 22 and a mowing head 26 having a spindle receiver 24 of as shown in either FIG. 1 or FIG. 2; (2) providing a plurality of cylindrical shaft extensions 30 such as those designated as shaft extension 10a, 10b, and 10c as shown in FIG. 3; (3) creating a shaft extender 10 by selecting at least one shaft extension from the plurality of shaft extensions 30 shown as shaft extension 10a; (4) detaching the output shaft spindle 20 at the end of the drive shaft housing 22 from the spindle receiver 24 of the mowing head 26; (5) attaching the threaded spindle bore 15 of the selected shaft extension 10a of the shaft extender 10 to the output shaft spindle 20 of the string trimmer; and (6) attaching the threaded shaft 16 of the selected shaft extension 10a of the shaft extender 10 to the spindle receiver 24 of the mowing head 26 to secure the mowing head 26 in place on the string trimmer.

The method of the present invention also includes the steps of (1) detaching the threaded spindle bore 15 of the selected shaft extension 10a of the shaft extender 10 from the output shaft spindle 20; (2) detaching the threaded shaft 16 of the selected shaft extension 10a of the shaft extender 10 from the spindle receiver 24 of the mowing head 26 to release the mowing head 26; and (3) attaching the spindle receiver 24 of the mowing head 26 to the output shaft spindle 20 of the string trimmer to return the string trimmer to its original configuration.

The method of the present invention, as shown in FIGS. 8 and 9 by way of example, may also be comprised of the steps of (1) providing a string trimmer having a rotatable threaded output shaft spindle 20 at the end of the drive shaft housing 22 and a mowing head 26 having a spindle receiver 24 of as shown in either FIG. 1 or FIG. 2; (2) providing a plurality of cylindrical shaft extensions 30 such as those designated as shaft extension 10a, 10b, and 10c as shown in FIG. 3; (3) selecting first and second shaft extensions, such as shaft extensions 10a and 10c, from the plurality of shaft extensions 30; (4) creating a shaft extender 10 by threadedly attaching the threaded shaft 16 of the first selected shaft extension 10a to the threaded spindle bore 15 of the second selected shaft extension 10c; (5) attaching the threaded spindle bore 15 of the first selected shaft extension 10a of shaft extender 10 to the output shaft spindle 20 of the string trimmer; and (6) attaching the threaded shaft 16 of the second selected shaft extension 10c of the shaft extender 10 to the spindle receiver 24 of mowing head 26 to secure the mowing head 26 in place on the string trimmer.

It is thought that the shaft extensions of the plurality of shaft extensions 30 depicted in FIG. 3 will be manufactured from a suitable metal allow such as steel or aluminum alloys including stainless steel alloys. However, depending upon the particular type string trimmer to be adopted, the shaft extensions of the plurality of shaft extensions 30 may be manufactured from polymer materials including fiber reinforced polymer materials. The threaded elements of the shaft extensions of the plurality of shaft extensions 30, i.e. the spindle bores 15 and the threaded shafts 16, will match and correspond to each other and to the threaded elements of the string trimmers being customized, i.e., the output shaft spindles 20 and spindle receivers 24 of the mowing heads 26.

The plurality of cylindrical shaft extensions 30 allows a user to selectively choose one or more shaft extensions of a desired length from the plurality of cylindrical shaft extensions 30. The selected cylindrical shaft extension, or extensions, such as cylindrical shaft extension 10a may then be used alone or connected together to create a shaft extender 10 to be attached between the output shaft spindle 20 and mowing head 26 of string trimmers to extend the length of the output shaft spindle 20 (and correspondingly the drive shaft) of the string trimmers in order to make the string trimmers more comfortable and more effective for use by user taller than those of average height.

The embodiments of the invention described herein are intended to be illustrative but not limiting and variations and changes may be made without departing from the spirit and scope of the invention as defined in the following claims.

I claim:

1. In a string trimmer having a threaded output shaft spindle and a mowing head having a threaded spindle receiver, a shaft extender for extending said threaded output shaft spindle of said string trimmer comprising:
(a) a shaft extension having a threaded spindle bore and a threaded shaft, and
(b) wherein said shaft extender is threadedly connected between said threaded output shaft spindle and said mowing head of said string trimmer.

2. The shaft extender as recited in claim 1, wherein:
(a) said shaft extension has an elongated body of a desired length, an upper end, and a lower end;
(b) wherein said threaded spindle bore is at said upper end of said elongated body of said shaft extension; and
(c) wherein said threaded shaft is at said lower end of said elongated body of said shaft extension.

3. The shaft extender as recited in claim 2, wherein said shaft extender includes a first said shaft extension threadedly connected to a second said connected shaft extension.

4. The shaft extender as recited in claim 3, wherein:
(a) said threaded spindle bore of said upper end of said elongated body of said first shaft extension is threadedly engaged with said threaded output shaft spindle of said string trimmer;
(b) said threaded shaft of said lower end of said elongated body of said first shaft extension is threadedly engaged with said threaded spindle bore of said upper end of said elongated body of said second shaft extension; and
(c) said threaded shaft of said second shaft extension is threadedly engaged with said threaded spindle receiver of said mowing head.

5. The shaft extender as recited in claim 4, wherein said first and said second shaft extensions are selected from a plurality of shaft extensions.

6. The shaft extender as recited in claim 5, wherein said elongated body of said first shaft extension and said elongated body of said second shaft extensions is cylindrical.

7. A shaft extender assembly for use in string trimmer, said string trimmer having a threaded output shaft spindle threadedly attached to a threaded spindle receiver of a mowing head, the shaft extension assembly comprising:
(a) a plurality of shaft extensions, each said shaft extension of said plurality of shaft extensions having an elongated body with an upper end having a threaded spindle bore and a lower end having a threaded shaft; and
(b) wherein said threaded spindle bore of each said shaft extension of said plurality of shaft extensions is threaded to correspond with and attach to said threaded output shaft spindle of said string trimmer and said threaded shaft of each said shaft extension of said plurality of shaft extensions is threaded to correspond with and attach to said threaded spindle receiver of said mowing head of said string trimmer.

8. The shaft extender assembly as recited in claim 7, wherein:
(a) said threaded spindle bore of said upper end of said elongated body of a selected shaft extension from said plurality of shaft extensions is threadedly engaged with said threaded output shaft spindle of said string trimmer; and
(b) wherein said threaded shaft of said lower end of said elongated body of a selected shaft extension is threadedly engaged with said threaded spindle receiver of said mowing head.

9. The shaft extender assembly as recited in claim 8, wherein:
(a) said threaded shaft of said lower end of said elongated body of a first selected shaft extension is threadedly engaged with said threaded spindle bore of a second selected shaft extension from said plurality of shaft extensions;
(b) said threaded spindle bore of said upper end of said elongated body of said first selected shaft extension from said plurality of shaft extensions is threadedly engaged with said threaded output shaft spindle of said string trimmer; and
(c) said threaded shaft of said lower end of said elongated body of said second selected shaft extension is threadedly engaged with said threaded spindle receiver of said mowing head.

10. The shaft extender assembly as recited in claim 9, wherein each said elongated body of each said shaft extension of said plurality of shaft extensions has a different length from that of other said shaft extensions of said plurality of shaft extensions.

11. The shaft extender assembly as recited in claim 10, wherein each said elongated body of each said shaft extension of said plurality of shaft extensions is cylindrical.

12. A method for selectively extending the length of the threaded output shaft spindle of a string trimmer, said method comprising the steps of:
(a) providing a string trimmer having a rotatable threaded output shaft spindle threadedly attached to a threaded spindle receiver of a mowing head;
(b) providing a plurality of shaft extensions, each said shaft extension of said plurality of shaft extensions having an elongated body with an upper end having a threaded spindle bore and a lower end having a threaded shaft, wherein said threaded spindle bore of each said shaft extension of said plurality of shaft extensions is threaded to correspond with and attach to said threaded output shaft spindle of said string trimmer and said threaded shaft of each said shaft extension of said plurality of shaft extensions is threaded to correspond with and attach to said threaded spindle receiver of said mowing head of said string trimmer;
(c) selecting at least one shaft extension from said plurality of shaft extensions;
(d) detaching said output shaft spindle from said spindle receiver of said mowing head;
(e) threadedly attaching said selected shaft extension to said output shaft spindle at said threaded spindle bore of said selected shaft extension; and
(f) threadedly attaching said threaded shaft of said selected shaft extension to said spindle receiver of said mowing head thereby releaseably securing said mowing head to said selected shaft extension.

13. The method for selectively extending the length of the threaded output shaft spindle of a string trimmer recited in claim 12 further comprising the steps on
(a) detaching said threaded spindle bore of said selected shaft extension from said output shaft spindle of said string trimmer;
(b) detaching said threaded shaft of said selected shaft extension from said spindle receiver of said mowing head; and
(c) attaching said spindle receiver of said mowing head to said output shaft spindle of said string trimmer.

14. The method for selectively extending the length of the threaded output shaft spindle of a string trimmer recited in claim 13, and wherein each said threaded spindle bore and each said threaded shaft of each said shaft extension of said plurality of shaft extensions are configured to threadedly engage with each other.

15. The method for selectively extending the length of the threaded output shaft spindle of a string trimmer recited in claim 14 wherein at least two shaft extensions are connected together for attachment between said output shaft spindle and said spindle receiver of said mowing head.

16. The method for selectively extending the length of the threaded output shaft spindle of a string trimmer recited in claim 15, and wherein said elongated body of each said shaft extension of said plurality of shaft extensions has different length from other said shaft extensions included in said plurality of shaft extensions.

17. The method for selectively extending the length of the threaded output shaft spindle of a string trimmer recited in claim 16 wherein each said elongated body of each said shaft extension of said plurality of shaft extensions is cylindrical.
